(19) United States
(12) Patent Application Publication
(10) Pub. No.: US 2015/0146432 A1
(43) Pub. Date: May 28, 2015

(54) LIGHT SOURCE MODULE

(71) Applicant: HON HAI PRECISION INDUSTRY CO., LTD., New Taipei (TW)

(72) Inventors: CHAU-JIN HU, New Taipei (TW); FENG-YUEN DAI, New Taipei (TW); YUNG-LUN HUANG, New Taipei (TW)

(73) Assignee: HON HAI PRECISION INDUSTRY CO., LTD., New Taipei (TW)

(21) Appl. No.: 14/105,153

(22) Filed: Dec. 12, 2013

(30) Foreign Application Priority Data
Nov. 27, 2013 (TW) 102143338

(51) Int. Cl. F21V 13/08

(52) U.S. Cl. CPC F21V 13/08
USPC 362/307

(57) ABSTRACT

The present disclosure relates to a light source module. The light source module includes a shell, a diffusing sheet, a light source and a reflective element. The shell includes a bottom plate and a side plate connected to and surrounding the bottom plate. Inner surfaces of the bottom plate and the side plate are reflective surfaces. The diffusing sheet is arranged on the side plate of the shell. The diffusing sheet and the shell cooperatively define a chamber. The light source is arranged on the bottom plate and received in the chamber. The reflective element is arranged on a light pathway of the light emitting element and received in the chamber. The reflective element is conical, and includes a conical surface facing the light source and a top surface away from the light source. The conical surface is a total reflective surface.

### BACKGROUND

1. Technical Field

The disclosure relates to light source modules, and particularly to a light source module with even distribution of light emission.

2. Description of Related Art

Light emitting diodes' (LEDs) many advantages, such as high luminosity, low operational voltage, low power consumption, compatibility with integrated circuits, easy driving, long term reliability, and environmental friendliness have promoted their wide use as a lighting source.

However, the conventional LED illumination apparatus generally has a radiation angle about 120 degrees and generates a butterfly-type light field. The intensity of light emitted by the LED illumination apparatus dramatically decreases when the radiation angle exceeds 120 degrees. When using such LEDs as light source of a light source module, a reflective shell is needed to reflect light emitted from the LEDs for illuminating; therefore, a height of the light source module is enhanced.

Therefore, what is needed is a light source module which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present light source module for microminiaturization. Moreover, in the drawing, like reference numerals designate corresponding parts throughout the whole view.

FIG. 1 is a schematic, isometric view of a light source module according to a first embodiment of the present disclosure.

FIG. 2 is a cross-sectional view of the light source module of FIG. 1, taken along line II-II thereof.

FIG. 3 is a cross-sectional view of a light source module according to a second embodiment of the present disclosure.

### DETAILED DESCRIPTION OF EMBODIMENTS

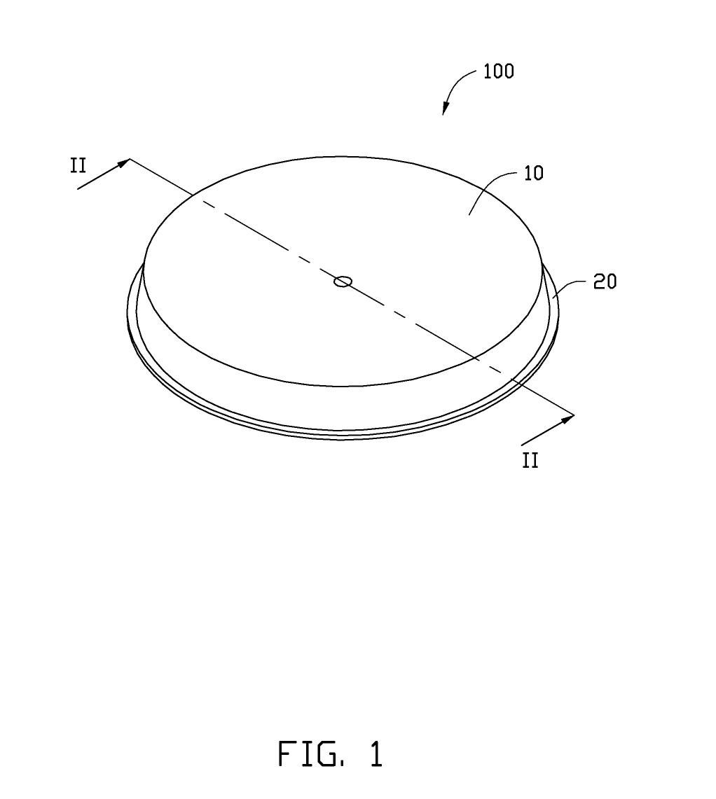

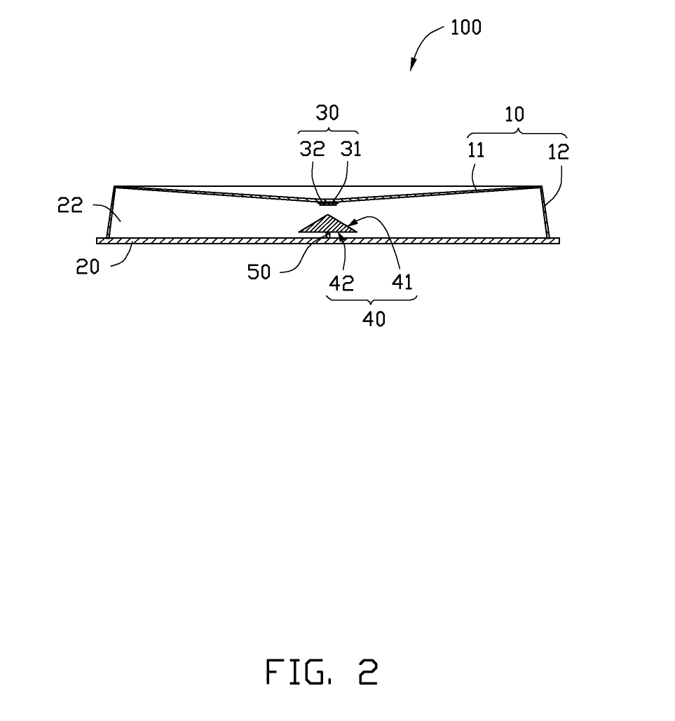

Referring to FIGS. 1 and 2, a light source module 100 in accordance with a first embodiment of the present disclosure is illustrated. The light source module 100 includes a shell 10, a diffusing sheet 20, a light source 30, a reflective element 40 and a fixing pole 50.

The shell 10 includes a bottom plate 11 and a side plate 12 connected to and surrounding the bottom plate 11. Inner surfaces of the bottom plate 11 and the side plate 12 are reflective surfaces. The side plate 12 extends upwardly and outwardly from the bottom plate 11 to the diffusing sheet 20. In the present embodiment, the bottom plate 11 is integrally formed with the side plate 12 as one piece. A center portion of the bottom plate 11 is convex towards the reflective element 40. The bottom plate 11 and the side plate 12 form a joint therebetween, a distance between the joint and the diffusing sheet 20 is larger than that between the center portion of the bottom plate 11 and the reflective element 40. A concave is defined outside the shell 10 by bottom plate 11, and is surrounded by the bottom plate 11.

The diffusing sheet 20 is arranged on the side plate 12 of the shell 10. The diffusing sheet 20 and the shell 10 cooperatively define a chamber 22.

The light source 30 is arranged on the bottom plate 11 and received in the chamber 22. The light source 30 includes a base 31 arranged on the center portion of the bottom plate 11 and a light emitting element 32 arranged on the base 31. In the present embodiment, the light emitting element 32 is LED, and a central axis of the light emitting element 32 is coaxial to that of the reflective element 40.

The reflective element 40 is arranged on a light pathway of the light emitting element 32 and received in the chamber 22. The reflective element 40 is substantially conical, and includes a conical surface 41 facing the light source 30 and a top surface 42 away from the light source 30. The conical surface 41 is a total reflective surface.

The fixing pole 50 is used to fix the reflective element 40 on the diffusing sheet 20. In the present embodiment, one end of the fixing pole 50 is fixed on the top surface 42 of the reflective element 40, and the other end of the fixing pole 50 is fixed on the diffusing sheet 20.

Parts of the light beams emitted from the light source 30 is reflected by the reflective element 40 divergently to the bottom plate 11 and the side plate 12 of the shell 10. The divergently reflected light beams are further diffused by the diffusing sheet 20 and then emitted to an outside. The other parts of light beams emitted from the light source 30 are directly reflected by the bottom plate 11 and the side plate 12 of the shell 10, and then further diffused by the diffusing sheet 20 and then emitted to an outside. Therefore, the light beams generated by the light emitting element 32 can be more uniformly. Furthermore, the reflective element 40 is received in the shell 10; therefore, the height of the light source module 100 is reduced.

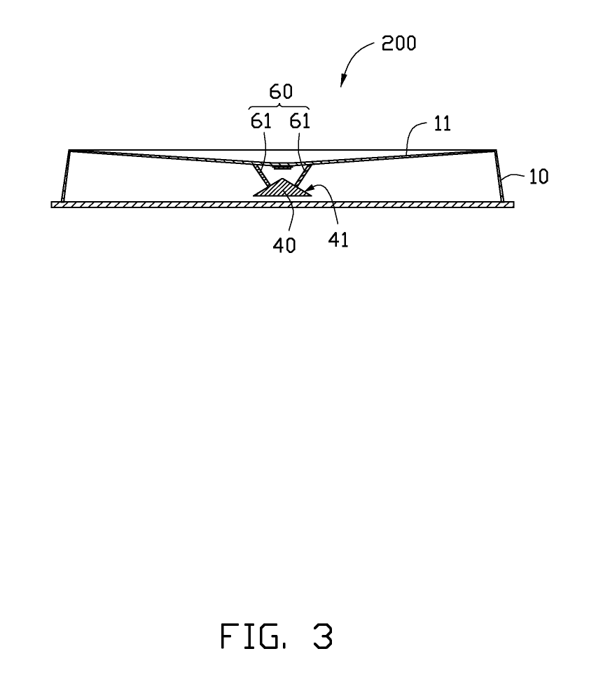

Referring to FIG. 3, a light source module 200 in accordance with a second embodiment of the present disclosure is illustrated. The light source module 200 differing from the light source module 200 is the reflective element 40 fixed on the bottom plate 11 of the shell 10 via a supporting unit 60. The supporting unit 60 includes a plurality of supporting elements 61. In the present embodiment, the light source module 200 includes three supporting elements 61 evenly arranged. One end of each supporting element 61 is fixed on the conical surface 41 of the reflective element 40, and the other end of each supporting element 61 is fixed on bottom plate 11 of the shell 10.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A light source module comprising:
a shell comprising a bottom plate and a side plate connected to and surrounding the bottom plate, inner surfaces of the bottom plate and the side plate being reflective surfaces;
a diffusing sheet arranged on the side plate of the shell, the diffusing sheet and the shell cooperatively defining a chamber;
a light source being arranged on the bottom plate and received in the chamber; and
a reflective element arranged on a light pathway of the light emitting element and received in the chamber, the reflective element being conical, and comprising a conical surface facing the light source and a top surface away from the light source, the conical surface being a total reflective surface.

2. The light source module of claim 1, further comprising a fixing pole for fixing the reflective element on the diffusing sheet, one end of the fixing pole being fixed on the reflective element, and the other end of the fixing pole being fixed on the diffusing sheet.

3. The light source module of claim 1, further comprising a supporting unit for fixing the reflective element on bottom plate of the shell.

4. The light source module of claim 3, wherein the supporting unit comprising a plurality of supporting elements, one end of each supporting element being fixed on the conical surface of the reflective element, and the other end of the each supporting element being fixed on the bottom plate of the shell.

5. The light source module of claim 1, wherein the side plate extends upwardly and outwardly from the bottom plate to the diffusing sheet.

6. The light source module of claim 1, wherein the bottom plate is integrally formed with the side plate.

7. The light source module of claim 1, wherein the light source comprises an LED, and a central axis of the LED is coaxial to that of the reflective element.

8. The light source module of claim 1, wherein a center portion of the bottom plate is convex towards the reflective element.

9. The light source module of claim 1, wherein the bottom plate and the side plate form a joint therebetween, and a distance between the joint and the diffusing sheet is larger than that between the center portion of the bottom plate and the reflective element,

10. The light source module of claim 1, wherein a concave is defined outside the shell by bottom plate, and is surrounded by the bottom plate.
